(19) United States
(12) Patent Application Publication
(10) Pub. No.: US 2006/0010209 A1
(43) Pub. Date: Jan. 12, 2006

(54) Server for sending electronics messages

(76) Inventor: Paul W Hodgson, Woodbridge (GB)

Correspondence Address: NIXON & VANDERHYE, PC, 901 NORTH GLEBE ROAD, 11TH FLOOR, ARLINGTON, VA, 22203, US

(21) Appl. No.: 10/522,919

(22) PCT Filed: Aug. 7, 2003
(86) PCT No.: PCT/GB03/03468

§ 371 Date: Jan. 31, 2005

(30) Foreign Application Priority Data
Aug. 7, 2002 (GB) 0218315.0
Feb. 5, 2003 (GB) 0302631.7

(51) Int. Cl. G06F 15/16

(52) U.S. Cl. 709/206

(57) ABSTRACT

The present invention is concerned with a method of, and apparatus for, detecting the source and movement of emails that are propagated by an email virus. The invention comprises a server configured to send outgoing electronic messages on behalf of terminals connected thereto and to deliver incoming electronic messages to the terminals, each terminal being accessed by one or more users. The server comprises: receiving means arranged to receive data relating to such electronic messages; analysing means arranged to analyse the received data in accordance with a specified criterion, so as to identify those electronic messages that satisfy the criterion; identifying means arranged to identify the destination of the identified electronic messages; processing means arranged to send a message to each of the identified destinations, requesting suspension of delivery of the identified electronic messages. This therefore allows suspect electronic messages (emails) to be identified, and recalled, or quarantined at a destination server, thereby preventing the spread of suspect emails as early as possible. The method also collates and presents email activity as a function of the position, within an organization, of the origin of an email. The email activity can be presented graphically, thus providing an enhanced user interface to email data within a company. In other words, awareness of movement of emails within a company is greatly enhanced. This represents an improvement over the prior art, because it provides a faster way of identifying potential viral damage within, for example, a company intranet.

The present invention relates to methods of, and apparatus for, controlling propagation of electronic messages through a network, and has particular application in identifying email activity within an organisation.

Email is the most widely used application because it offers a fast, convenient method of transferring information. Its ability to communicate information quickly, seemingly independent of distance between sender and receiver, is one of the key features that makes email so attractive. Typically, these features can be exploited in a positive manner—e.g. to improve and increase the quality and quantity of business transactions. However, these features can also be exploited in a negative manner—by so-called “viruses”—to cause disruption and even loss of data to the email recipient.

A virus is a piece of programming code, usually disguised as something else, that causes some unexpected and usually undesirable event, and which is often designed so that it is automatically spread to other computer users. The most common transmission means for a virus is by e-mail, usually as an attachment. Some viruses are invoked as soon as their code is executed; other viruses lie dormant until circumstances cause their code to be executed by a computer.

Known methods applied to virus detection include maintaining a library of known viruses, together with software for searching for these known viruses (e.g. McAfee™ and Dr Solomons™, generally referred to as “anti-viral” software), and using the software to scan incoming emails. Such software essentially carries out analysis of byte-signatures of files in order to identify files having signatures corresponding to the known viruses.

Other known methods for identifying email viruses, such as that employed in McAfee's product “Outbreak Manager”, involve analysing incoming email messages in accordance with certain criteria, and quarantining incoming messages if certain patterns, such as an inordinate number of e-mail messages with the same subject line or the same attachment, are detected. Although this approach claims to concentrate on analysing the behaviour of emails, it analyses emails with respect to certain features of the emails, and thus inevitably relies on some a priori email knowledge.

A virus is often a minor, yet difficult to predict, modification of previously seen viruses. Known methods used to catch such viruses have recently been reviewed in an article, published on the BBC website on 22^{nd} May 2002, entitled “Waging war on computer viruses” (website address at date of filing is http:\\news.bbc.co.uk/1/hi/sci/tech/1999854stm. Usually a website address takes the form of a first part indicating the network delivery mechanism (e.g. http:// or file:// for the hypertext transfer protocol or file transfer protocol respectively) followed by the network address of the server (e.g. www.server 1.com) suffixed with the name of the file that is being requested. Note that, in this example, such names are, for typographical reasons, shown with the “//” replaced by “\\”)).

One passage in the article states “anti-virus companies work to produce a ‘pattern’ file that tells their software how to spot and stop the [malicious program]”. A pattern file is a signature matching file. A further passage reports that “many anti-virus programs use rule-based techniques, called heuristics, to spot these variants”. Heuristics are essentially Artificial Intelligence rule-based techniques that are used to estimate the probability that a piece of code is a virus.

According to a first aspect of the present invention, there is provided a server configured to send outgoing electronic messages on behalf of terminals connected thereto and to deliver incoming electronic messages to the terminals, each terminal being accessed by one or more users. The server comprises:

receiving means arranged to receive or generate log data relating to one or more traffic characteristics associated with electronic messages;

analysing means arranged to analyse the log data in accordance with a criterion, so as to identify those electronic messages that satisfy the criterion;

identifying means arranged to identify the destination of the identified electronic messages; and

processing means arranged to send a message to each of the identified destinations, requesting suspension of delivery of the identified electronic messages.

The log data may relate to the volume of data passing at a point along a data path or link in a time interval, in particular the volume of data originating from the same user or location in a time interval. In particular, the log data relating to a target electronic message may indicate the volume of data or the number of messages originating (or received) from a common user, terminal, router or other topological position within a time interval. Conveniently, the log data may indicate the size of a message, as the message size is normally an indication of the minimum amount of data sent by a user in a time interval. Preferably, the time interval is a time interval during which the taget message was sent or received. Alternatively or in addition, the log data may include an indication of the type or format of an electronic message, such that for example the number of messages of a given type or format originating from a user in a time interval at a topological location can be ascertained. Thus, the term log data will be understood to include data which can be associated with the content of an electronic message.

An example of an electronic message is a so-called email. Another example of an electronic message is a file, which is stored, for example, on a file server, and which contains a message. Alternatively, an electronic message may be data generated by a web browser.

The analysing means could be arranged to analyse log data each electronic message sent from a terminal connected to the server, and to identify those that satisfy the criterion. An example of the specified criterion is any one, or some, of type of electronic message, size of electronic message and number of electronic messages emanating from a user. By “type” of electronic message, in the context of email, we mean whether the email contains plain text; whether it contains an attachment, and if so, what type of attachment there is; whether there is a URL embedded therein; and where the email originated from, etc. The analysing means thus identifies potentially suspicious emails.

A specified criterion may be met when the log data relating to a target electronic message indicates that a threshold number of electronic messages and/or a threshold data volume originates from a common terminal or user, in a time interval during which the target electronic message was sent. This will allow bursts of data flow which can be associated with the propagation of viruses to be detected, so that the presence of a virus can be inferred.

Preferably the server includes first means arranged to receive a signal identifying whether or not an identified electronic message is related to an electronic message virus. This signal could come from, for example, an email virus laboratory; the server could be arranged to send the identified electronic messages to such a laboratory, and receive the results therefrom.

Conveniently the server includes second means arranged to receive data indicative of the success or otherwise of the suspension request. In the event that the received signal identifies an electronic message to be a virus and the suspension request is successful, the second means triggers deletion of the said electronic message. This could involve sending a message to the destinations that have been confirmed to have received a virus, and causing the said server to delete such an electronic message.

In the event that the received signal identifies an electronic message to be a virus and the suspension request is unsuccessful, the second means is arranged to trigger operation of identifying means and processing means running on a server corresponding to the destination of the identified electronic message.

Consider the scenario where terminal A, connected to server S1 and running email client software on behalf of user U1, sends emails to user U2, registered with terminal B, which is connected to server S4. Further, assume that servers S1 and S4 are configured in accordance with the invention. In the event that the analysing means finds that emails sent from U1 to U2 satisfy the specified criterion and are also identified to be a virus, server S1 will monitor the result of the suspension request sent to server S4. If the suspension request sent to email server S4 is unsuccessful, the second means running on server S1 will send a message to email server S4, invoking operation of the identifying means and processing means running thereon, in respect of any emails sent from user U2.

Preferably, in the event that a received signal identifies an electronic message not to be a virus and the request is successful, the second means is arranged to permit delivery of the identified electronic message. Thus, in the context of the example above, in the event that emails sent from U1 to U2 are not identified to be a virus, the second means running on S1 sends a message to server S4, permitting delivery of these emails.

Thus in a preferred arrangement, there is a plurality of the above-described servers, and at least one of them comprises:

receiving means arranged to receive a request to suspend delivery of an identified electronic message;

polling means arranged to check whether or not the identified electronic message has been delivered, and if it has not, to block retrieval thereof by a respective terminal connected thereo;

wherein, in response to receipt of a said request, the polling means is arranged to check delivery of the identified electronic message, and in the event that it has not been delivered, to block retrieval thereof.

In the context of the example given above, server S4 would implement this functionality. Server S4 would also include deleting means arranged to check whether retrieval of the identified electronic message has been blocked, and, in the event that the identified electronic message is both identified to be a virus and has been blocked, the deleting means deletes it.

Suspension of delivery can take many forms, and in a preferred arrangement, involves blocking retrieval of an email by user U2. Blocking retrieval can be effected by either changing the permissions of these identified emails, so that the user U2 cannot see these emails, or it can be effected by removing the identified emails from the user U2's mailbox. When a message is received, permitting delivery, the server S4 either changes the permissions in respect thereof, so that the user U2 can now see the email, or the server moves the email into the user U2's mailbox.

The advantage of this first aspect of the invention is that potentially suspect emails can be retrieved and deleted as early as possible, thereby preventing the spread of viruses throughout the intranet (i.e. company).

According to a second aspect of the present invention the server is additionally or alternatively provided with the following features:

first storage for storing details relating to such electronic messages;

further storage for storing a mapping between users and the organisational units to which the users belong,

display means for displaying a plurality of images, each representative of an organisational unit;

wherein the server is arranged, in use, such that in response to a request for data relating to a user,

the first storage is arranged to output data identifying electronic messages emanating from that user;

the further storage is arranged to output data identifying which of the organisational units that user belongs to;

and, for those electronic messages that are identified to satisfy the criterion, the display means is arranged to insert, on the image corresponding to the identified organisational unit, a visual identifier representative of the volume or type of identified electronic messages.

Preferably, for those electronic messages that are identified to satisfy the criterion, the display means is arranged to display a list of users on an associated image, and for each user on the list, to display details of the volume and/or type of identified electronic messages emanating therefrom.

Conveniently the display means is arranged to insert a link between the identified organisational unit and the organisational unit corresponding to the identified destination. Preferably the display means is arranged to display an indication of the success or failure of controlling the spread of a virus.

Thus, the present invention collates and presents email activity as a function of the position, within an organization, of the origin of an email. The email activity can be presented graphically, thus providing an enhanced user interface to email data within a company. In other words, awareness of movement of emails within a company is greatly improved. This is an improvement over known email virus identification methods, because it provides a faster way of identifying potential viral damage within, for example, a company intranet.

According to a third aspect of the invention, there is provided a method corresponding to the functionality provided by the server.

Further aspects of the invention are provided as specified in the appended claims.

In the following description the terms “host”, “intranet”, “client”, “device” and “email data” are used; these are defined as follows:

“client”—a requesting program, computer, or user in a client/server relationship;

“host”—any computer that has two-way access to other computers in a network such as the Internet or an Intranet; a client is a particular type of host.

“intranet”—a private network that is contained within an organisation. It may consist of many interlinked local area networks and also use leased lines in the Wide Area Network. Typically, an intranet includes connections through one or more gateway computers to the outside Internet. The main purpose of an intranet is to share company information and computing resources among employees in the organisation.

“device”—any machine that is operable to receive data delivered over a network. Examples of devices include hosts, clients, routers, switches, and servers.

“email data”—packet data that has emanated from an email application running on a first device en route for an email application running on a second device. Email data includes overhead data, which enables the packet to arrive at its destination, and is retrieved from the header part of a packet. Specifically email data includes at least protocol type, source address of packet, destination address of packet, size of payload of packet, and type of payload packet (which can be used to determine whether there is an attachment). A packet is identified as an email data type from examination of the protocol part of the header. The phrase “email packet data” and “email data” are used interchangeably in the following description.

Further aspects and advantages of the present invention will be apparent from the following description of preferred embodiments of the invention, which are given by way of example only and with reference to the accompanying drawings, in which

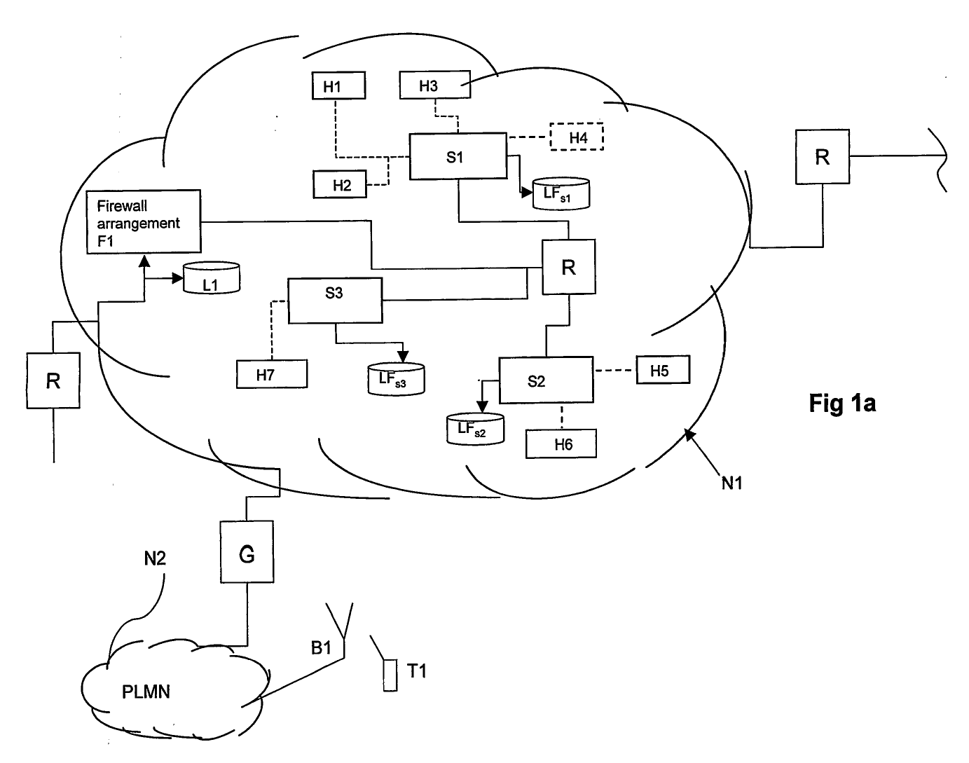

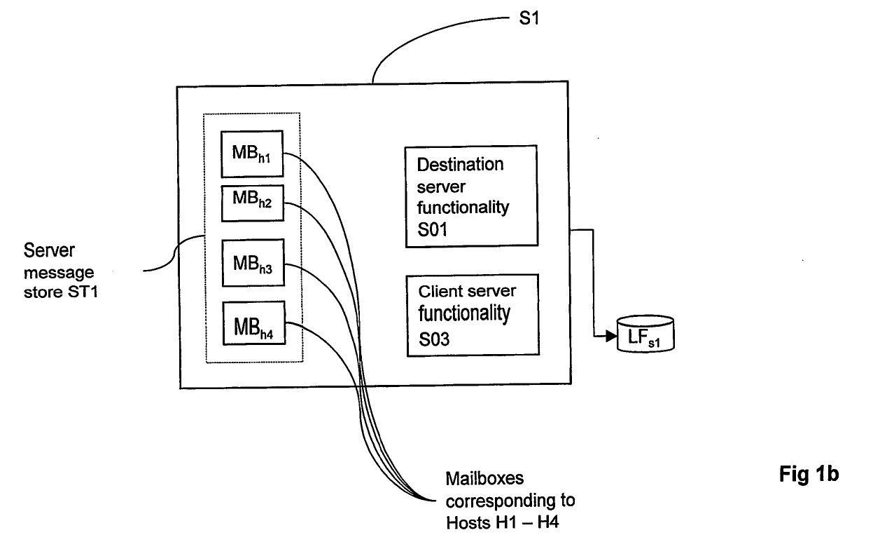

FIG. 1a is a schematic diagram of a network, within which embodiments of the invention operate;

FIG. 1b is a schematic diagram of processes and parts constituting a conventional email server;

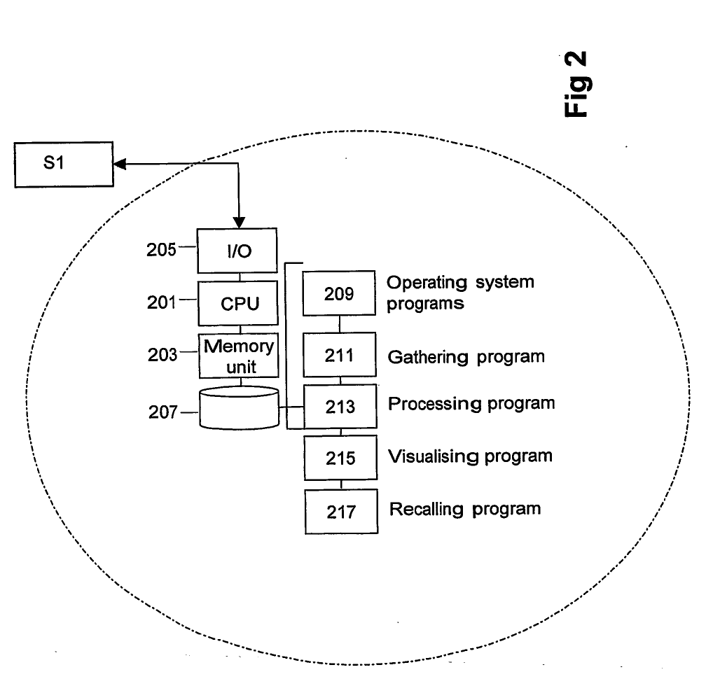

FIG. 2 is a schematic diagram of components of a virus detector according to the invention;

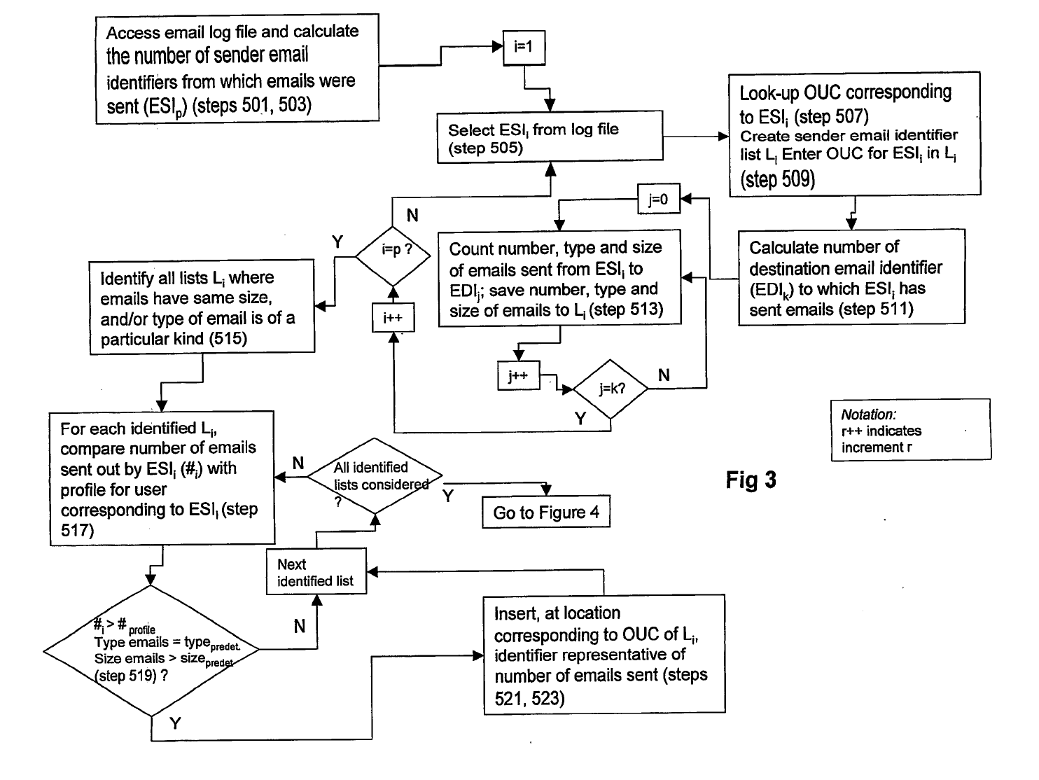

FIG. 3 is a flow diagram showing a method of identifying email behaviour according to an embodiment of the invention;

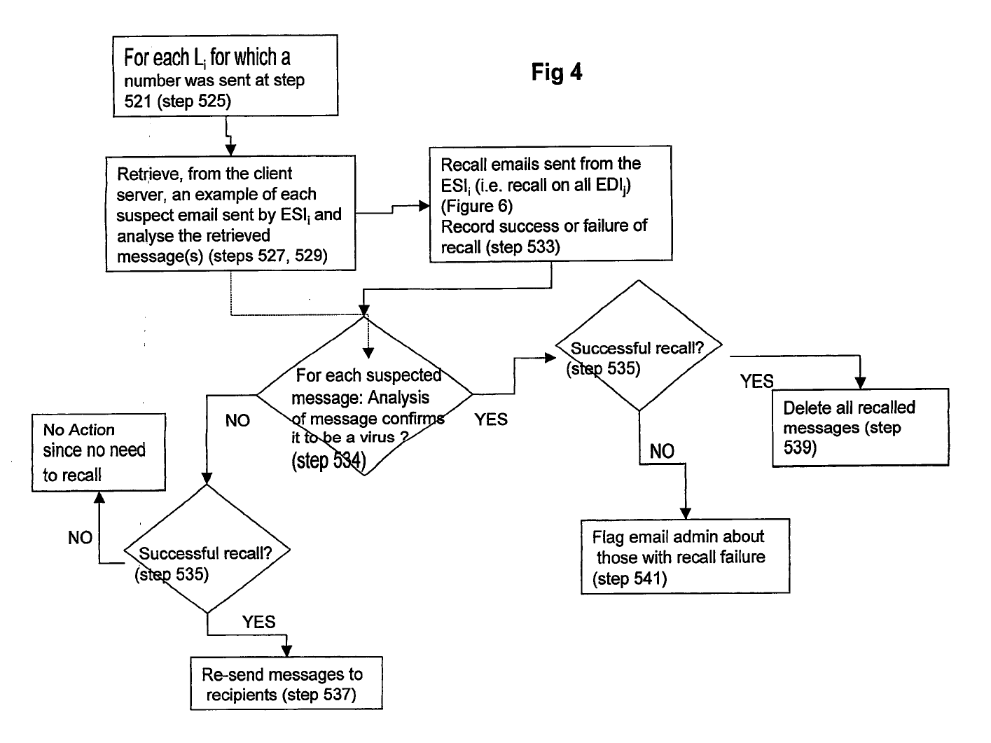

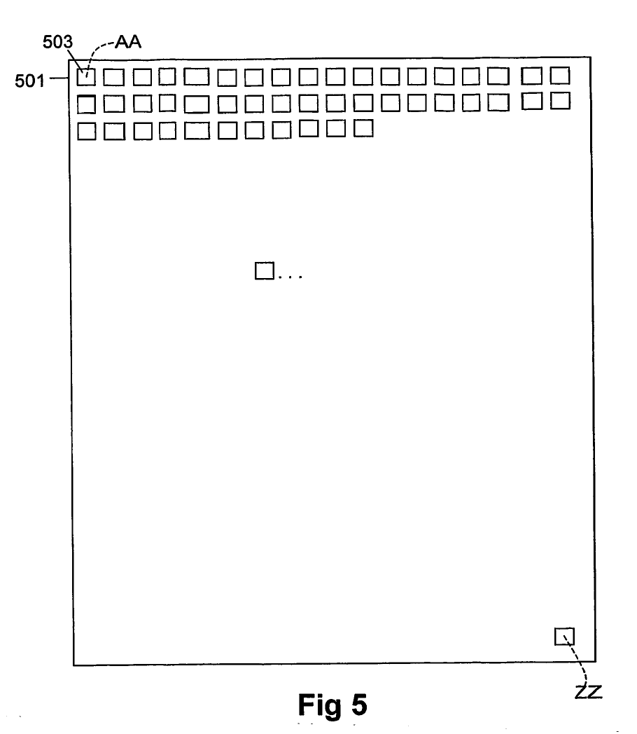

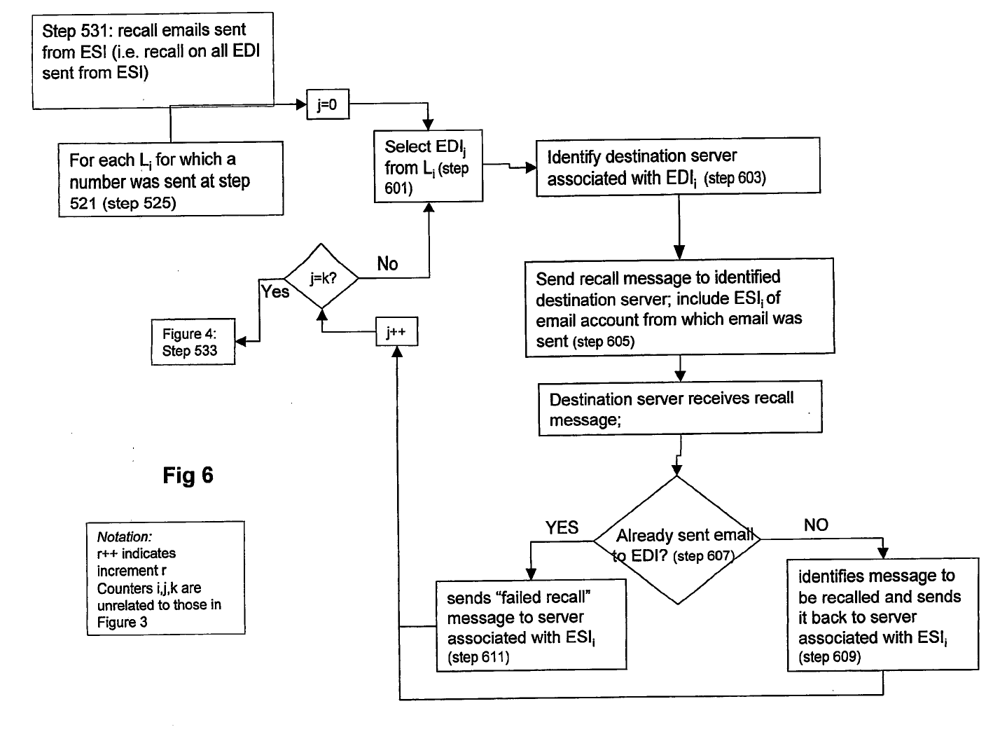

FIG. 4 is a flow diagram showing aspects of managing email traffic in dependence on the behaviour outlined in the method of FIG. 3;

FIG. 5 is a graphical representation of the form of output generated by the virus detector shown in FIG. 2;

FIG. 6 is a flow diagram showing further aspects of managing email traffic in dependence on the behaviour outlined in the method of FIG. 3;

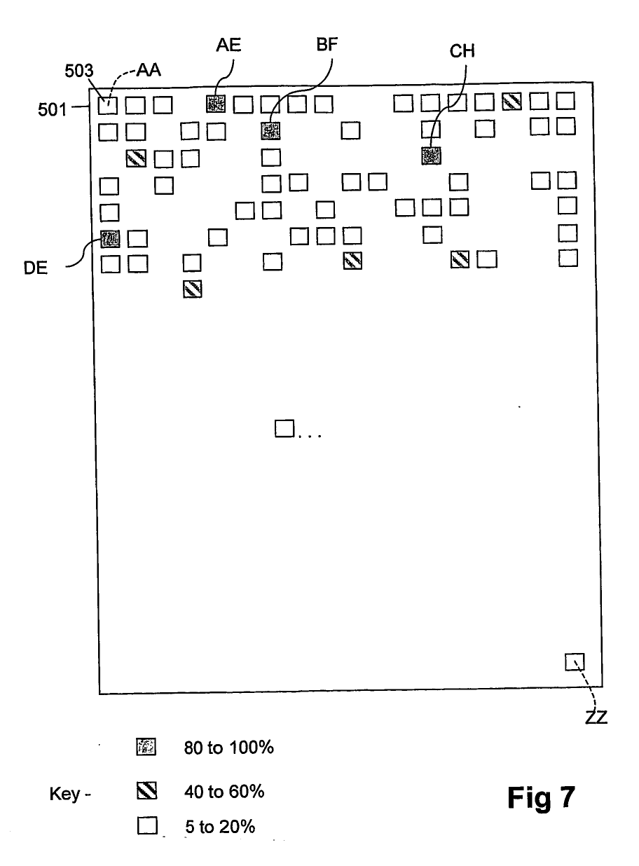

FIG. 7 is a graphical representation of the output of one of the steps shown in FIG. 3;

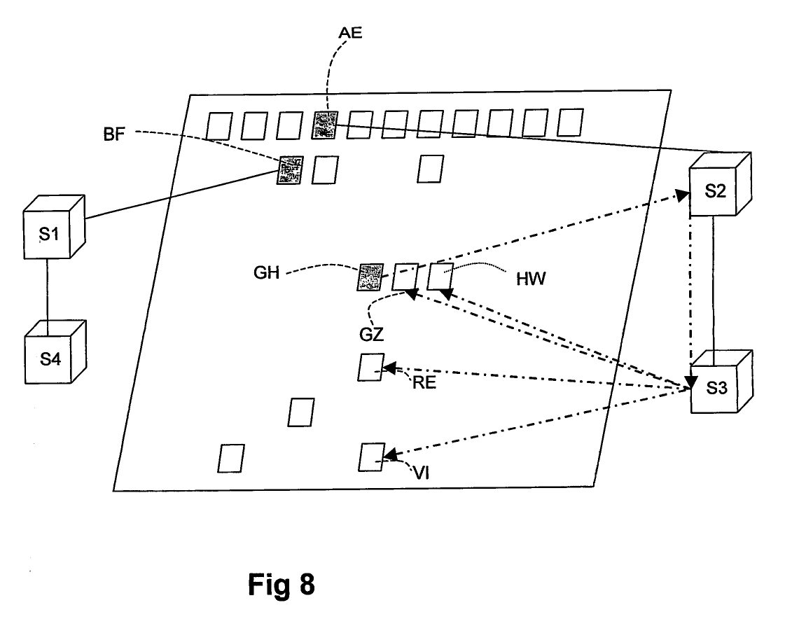

FIG. 8 is a graphical representation of the output of one of the steps shown in FIG. 4;

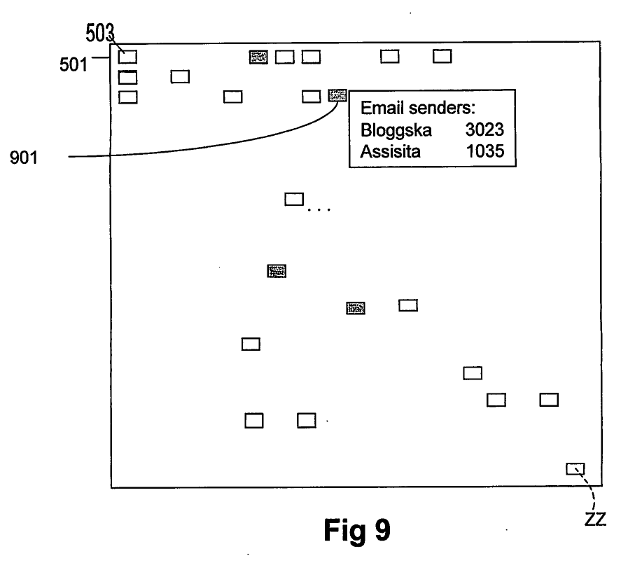

FIG. 9 is a further graphical representation of the form of output generated by the virus detector shown in FIG. 2; and

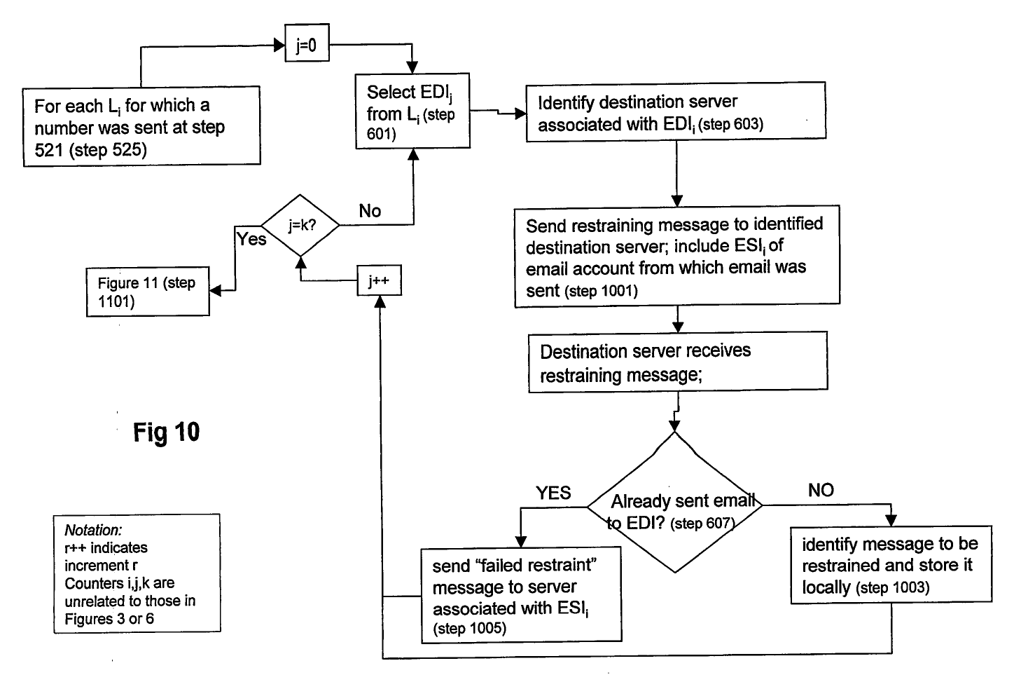

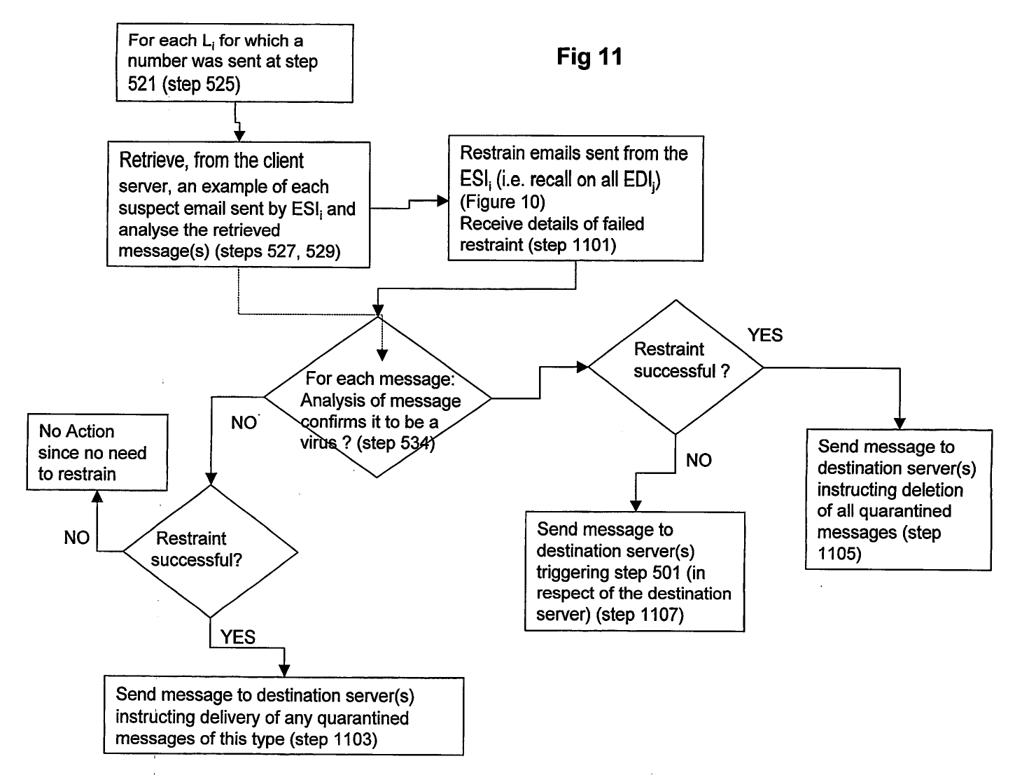

FIG. 10 is a flow diagram showing aspects of managing email traffic according to a second embodiment;

FIG. 11 is a flow diagram showing further aspects of managing email traffic according to a second embodiment;

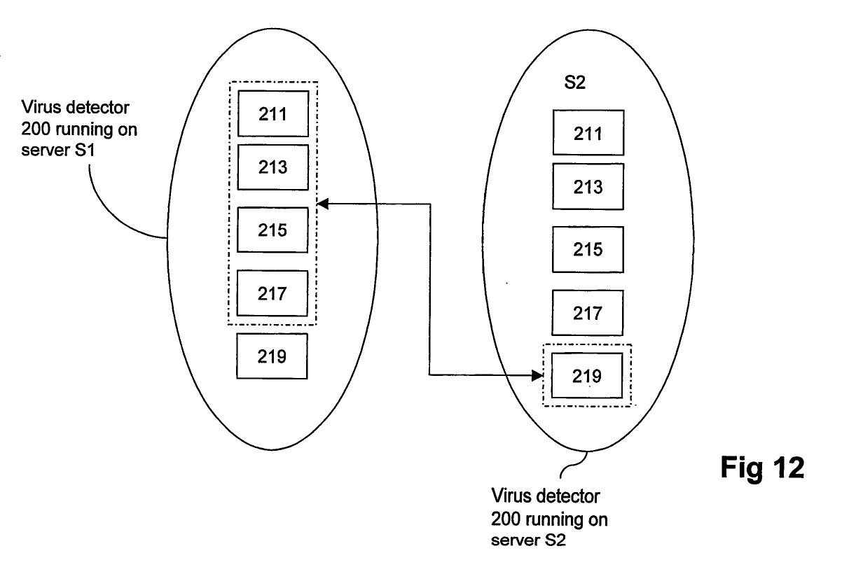

FIG. 12 is a schematic block diagram showing interrelationship between virus detectors according to embodiments of the invention; and,

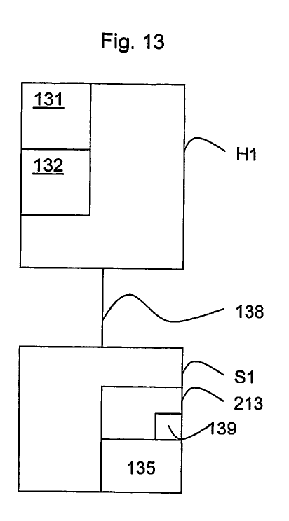

FIG. 13 shows a further embodiment.

### OVERVIEW OF OPERATING ENVIRONMENT FOR EMBODIMENTS OF THE INVENTION

FIG. 1a shows part of a network N1, having various devices operating therein. A network such as that shown in FIG. 1a can be perceived as comprising a plurality of functional networks, one of which is an email network. An email network can be separated into a plurality of logical email domains, each of which comprises a plurality of server machines and client machines communicating therewith. FIG. 1a shows part of a single logical email domain.

The network N1 could be a corporate network, typically comprising many interconnected Local Area Networks (LAN). The network N1 includes routers R (only one of which is shown, for clarity), which route data to devices in the network in a manner known in the art and host machines H1 . . . H7, which send and receive data, including email data, in a manner well known in the art. In the Figure, only a nominal number of host machines H1 . . . H7 are shown for clarity. The network N1 additionally includes several email servers S1 . . . Sn (only 3 shown for clarity), which receive and forward email from and to host machines H1 . . . H7 or to and from other email servers, and provide temporary storage of emails that are in transit to another destination. Each email server Si stores details of emails passing through it in a log file LFᵢ. The dashed links shown in FIG. 1a indicate email traffic passing between email server and host machine; for other communications, each of the host machines H1 . . . H7 may communicate directly with the router R.

As shown in FIG. 1a, a public land mobile network (PLMN) (e.g. a GSM—compatible digital cellular network) N2 is connected via a gateway G to the LAN N1. A base station B1 of the PLMN provides a cell in the vicinity of terminal T1, which is enabled to send and receive email messages (typically by having an email client running thereon) to hosts H1 . . . H7 in the network N1. Since terminal T1 can send and receive emails in the same manner as hosts H1 . . . H7, for the purposes of the following description it is considered to be a host.

FIG. 1b shows parts of a conventional email server S1. An email server (also known as a messaging server) comprises processes adapted to attend to both outgoing and incoming email requests. The email server comprises means S01 for receiving and processing incoming email requests, which reads the destination address on incoming messages and delivers them to an appropriate mailbox stored on the server S1. Means SO1 provides what is commonly referred to as “destination server” functionality. The email server S1 also comprises means S03 for sending and processing outgoing email requests, which is configured to interact with other servers, or nodes, through which a message is passed, until the email reaches the network corresponding to its destination. Means S03 provides what is commonly referred to as “client server” functionality.

An email server can thus act as both client and destination server. Each email server S1 has a message store ST1, which comprises mailboxes MBi for each host Hi for which the email server S1 acts as client server (in the case of server S1, hosts H1 . . . H4). When a message arrives on the server S1, the receiving means or logging means SO1 identifies the recipient and stores the message in the mailbox corresponding to the recipient. The message is copied to the host when the recipient clicks on the message.

As stated above, the ability to communicate via email can be exploited by “viruses”, which can cause large-scale disruption in terms of device loading and loss of data. Most known methods applied to virus detection maintain a library of known viruses, together with software for searching for these known viruses (e.g. McAfee™ and Dr Solomons™, generally referred to as “anti-viral” software). These methods essentially perform analysis of byte-signatures of files in order to identify files having signatures corresponding to the known viruses.

A problem with these known approaches is that they are reactive—if a virus arrives at one of the hosts, say H1, then typically only if the virus has been seen before (and assuming that the host H1 has installed anti-viral software in respect of that virus) will the anti-viral software be effective. Thus, if host H1 were to receive an email that spawned a virus hitherto unseen, it would cause harm to the host H1, as there is currently no reliable means of detecting and halting the virus activity until it has been identified—i.e. after it has caused harm.

The method described in international patent application PCT/GB2002/003295 takes a significant step from the above-described methods by analysing patterns in previously seen email data in order to identify a plurality of classification groups, or profiles, each of which is indicative of particular type of email behaviour. When new email data arrives, embodiments of that method attempt to classify the email data into one of the known profiles. If the data falls within one of the known profiles, a predetermined action can be carried out—e.g. alerting a system administrator, or running a further diagnostic application, if the email data is of a particular type. PCT/GB2002/003295 also describes visualising the distribution of email traffic around the network, as a function of the relationship between email server and hosts (email clients). However, the visualisation is not scalable for a network comprising, e.g. 70 email servers, since only a snapshot of the client/servers can be visualised on the screen. A further problem with this method is that classification can lead to false positives and indecision, and general failure to reliably classify unseen email data, whilst the method can only alert a network administrator to the presence of a virus, and cannot stop the spread of the virus.

Thus although the approach disclosed in PCT/GB2002/003295 attempts to look at the macroscopic behaviour of email traffic, there is a number of shortcomings that limit its usefulness.

Embodiments of the present invention are concerned with proactively detecting email viruses, and make use of a crucial realisation that the spread of, and thus damage due to, email viruses is dependent on transmission from one machine to other machines. In particular, embodiments of the invention provide a user interface to email data within a company, thereby presenting information on the movement of emails within a company in terms of the origin of the email. One advantage of the approach described herein is that email activity within an entire company (comprising upwards of 120,000 employees) can be viewed on a single screen. Secondly, since the origin of an email can be traced to an employee (who has a well defined position within a company), information relating to the sector within an organization from which emails are emanating can easily be retrieved.

Thus the invention represents an improvement over the current state of the art by virtue of the fact that known email virus detection methods do not parse email log files and represent them in terms of employee/company structure.

### Overview of Embodiments of the Invention

Embodiments of the invention can be applicable to scenarios where users can be categorised in terms of their position within an organisation, such as a company. A company can be organised into organisational units, and each employee is then assigned to one of the organisational units. Such organisational units are referred to as “OUC”, meaning organisational unit code, in the following description.

Essentially, embodiments may analyse previously seen email data (in the form of email log files, stored, e.g. in email server log files LFi) and identify hosts that are sending an uncharacteristically large number of emails, and/or emails of a particular type and/or size. In this way, on the basis, at least in part, of the temporal distribution of traffic levels through or from a server (or a plurality of severs), the presence of a virus can be inferred.

For any or all hosts so identified, the position of the associated email user, with respect to the organisation within which the user is located, is identified, and an identifier identifying the number/size/type of emails sent by that user is displayed on a bespoke graphical user interface.

Subsequently, emails sent from the identified hosts are recalled, or temporarily quarantined, whilst an example of the email is retrieved from the email server (which is the “client server” of the identified host) and analysed by one or some of the above mentioned known email virus analysers (e.g. by sending the virus to Symantec™ analysis centre (discussed-below)). The recalling feature thus has the benefit of halting the spread of the virus. Preferably, if the results of the analysis show the emails to be viruses, the recalled emails are then deleted. Conversely, if the emails are not viruses, the recalled emails can be re-sent.

Referring to FIGS. 2 to 8, a first embodiment of the invention will now be described in more detail. FIG. 2 is a block diagram showing elements of the first embodiment, generally referred to as virus detector 200, while FIGS. 3 and 4 are flow diagrams showing steps carried out by the virus detector 200 (which is an example of inference means for inferring the presence of a virus). In these latter two Figures, the direction of arrows indicate the order in which steps are performed, and the dotted line in FIG. 4 indicates input of data. FIGS. 5, 7 and 8 are schematic diagrams showing a graphical representation of detected email activity, and FIG. 6 is a flow diagram showing further steps carried out by the virus detector 600, specifically in relation to recalling emails suspected to be virus-related.

Turning firstly to FIG. 2, the virus detector 200 runs on an email server S1, such as that shown in FIGS. 1a and 1b. In addition to the conventional email-related processes described above, the email server S1 comprises a central processing unit (CPU) 201, a memory unit 203, an input/output device 205 for connecting the server S1 to the network N1, storage 207, and a suite of operating system programs 209, which control and co-ordinate low level operation of the server S1. Such a configuration is well known in the art.

The virus detector 200 comprises at least some of programs 211, 213, 215, 217. These programs are stored on storage 207 and are processable by the CPU 201. The programs include a program 211 for gathering data, which collects unprocessed email data (log data), typically accessible from either the log file LF1 associated with the server S1 or from processes embedded in the email network whose purpose it is to gather such data (not shown). The virus detector 200 includes a program 213 for processing the gathered data in order to identify host machines that are sending an abnormal number/type/size of emails, and a visualising program 215, arranged to represent such identified hosts in the context of an organisational structure, together with recall program 217, which attempts to recall emails that have been sent from such identified clients.

Preferably there is a plurality of virus detectors 200, each of which runs on a destination email server. The interaction between virus detectors is described at the end of the description.

The operation of the viral detector 200, according to the first embodiment of the invention, will now be described with reference to the flowcharts shown in FIGS. 3, 4 and 6, and the schematic diagrams shown in FIGS. 5, 7 and 8.

Referring to FIG. 3, the gathering program 211 accesses 501 the email log file LF1 and identifies 503 the email accounts (hereinafter referred to as email sender identifiers (ESIᵢ)) from which emails have been sent. Typically the log file LF1 will store details of emails sent within a network, such as an intranet, or a Virtual Private Network (VPN), within a certain time period. Assuming that the virus detector 200 is operating within a company intranet, since individual email accounts are associated with individual users, each email sender identifier ESIᵢ will be associated with an employee (user). An email sender identifier ESIᵢ can be a user ID or a conventional email address.

At step 505, the processing program 213 selects a first email sender identifier ESI₁, and identifies 507 the organisational unit (OUC) corresponding to the selected email identifier ESI₁ (that is the organisational unit corresponding to the user having email identifier ESI₁). Such identification may involve querying a database in respect of the user corresponding to email identifier ESI₁ so as to retrieve a data identifying the unit to which he/she belongs.

At step 509, the processing program 213 creates a first sender email list L₁, and the user's details, including OUC identified at step 507 and email sender account details (including ESI₁), are stored in the list L₁. Next the processing program 213 parses email log file LF1 in order to calculate 511 the number of destinations, each having a respective email identifier (DEIₖ), that have been sent emails from the sender's email account ESI₁. Then for each of the destination email identifier DEIⱼ, the number, size and type of emails sent thereto are evaluated and saved to the list Lᵢ (step 513).

Once the emails sent from the first email sender identifier ESI₁ have been analysed and the results of the analysis saved to an associated list L₁, the processing program 213 selects 505 the next email sender identifier ESI₂ from the log file LF1 and repeats steps 507-513 in respect thereof. These steps are repeated until data in respect of all of the email sender identifiers identified by the gathering program 211 at step 503 have been analysed.

Thus steps 501-513 are parsing steps, the output of which is one or more lists, each comprising details of emails sent from an email account, together with data indicating the position, within an organisation, of the user associated with the email account.

Subsequently, at step 515, the processing program 213 analyses the content of each of the lists Lᵢ in order to identify email senders for whom a certain percentage of sent emails are of the same size, and/or are of the same type (the size of emails is not always used to identify viral activity because a clever virus could easily generate variable sized replications appending, for example, randomly generated data to an email before sending it). This percentage could be expected to vary depending on the level of paranoia. By “type” of email, we mean whether the email contains plain text; whether it contains an attachment, and if so, what type of attachment there is; whether there is a URL embedded therein; and where the email originated from.

Next, at step 517, the processing program 213 parses the lists identified at step 515, and, for each list so identified, compares the number of outgoing emails with an email behaviour profile for the user associated with the sender identifier. An email behaviour profile may take the following form:

| | | number | | | # replies | |
|---|---|---|---|---|---|---|
| Email sender | time of | of emails | number | types of | to received | # |
| identifier | day | sent | of dest's | emails | emails | initiated |
| bloggsma | 09.00- | 18 | 16 | attachments | 10 | 8 |
| [email address | 10.00 | | | plain text | | |
| bloggs@bestco.com] | | | | | | |
| bloggsma | 10.00- | 4 | 4 | plain text | 1 | 3 |
| [email address | 11.00 | | | | | |
| bloggs@bestco.com] | | | | | | |
| bloggsma | 11.00- | 2 | 2 | plain text | 0 | 2 |
| [email address | 12.00 | | | | | |
| bloggs@bestco.com] | | | | | | |

A profile may be created manually, or could be created by a supervised learning method (not shown), such as a neural network, cluster analysis and pattern matching or unsupervised learning methods such as Kohonen's Feature Mapping. Other methods include reinforcement learning methods.

Such methods are described in the book entitled “Machine Learning and Its Applications—Advanced Lectures”, edited by Paliouras, G., National Centre for Scientific Research “Demokritos”, Athens, Greece; Karkaletsis, V., National Centre for Scientific Research “Demokritos”, Athens, Greece; Spyropoulos, C. D., National Centre for Scientific Research “Demokritos”, Athens, Greece, which is published by Springer, 2001.

If a profile is created manually, each email sender would be expected, at the very least, to enter details of times at which he/she expects to send a large number of emails, and the times at which he/she expects to send the same email to a large number of people. If a profile is created using a supervised learning means, the learning means receives, as input, data from the email log file corresponding to a day of the week and time slots within each day—e.g. data corresponding to a typical Monday morning, 9:00-10:00 slot—whereupon it learns a pattern corresponding to each day and timeslots within the day.

At step 519, in the event that the number of emails recorded in a list does not correlate (within certain bounds of uncertainty) with the expected number of emails, and if the size and type of email satisfies the criteria listed in respect of step 515, the number of emails sent is sent 521 to the visualising program 215 for display.

At step 523, the visualising program 215 is arranged to present information graphically via a graphical user interface (GUI), specifically in response to receipt of data from the processing program 213. Referring to FIG. 5, the visualising program 215 creates a window 501 showing a two dimensional representation of a company structure, where each unit within the company is represented by a rectangle 503, and the rectangles are arranged in, e.g. alphabetical order, from top left to bottom right. When the visualising program 215 receives data from the processing program 213, it converts the data received at step 521 into a format suitable for representation (described below), identifies which of the organisational units the received data corresponds to, and modifies the window 501 at a location corresponding to the identified organisational unit (also described below).

In the event that a company is organised into numerous organisational units, so that it is impossible to represent each unit on a single screen, the GUI could comprise a plurality of windows. For example, if an organisational structure were hierarchical, each window could correspond to a level in the hierarchy and selection of a window could be provided by menu options, or similar. However, irrespective of the exact form of the GUI, when data is received from the processing program 213, the visualising program 215 identifies, in the window being displayed, the organisational unit that the received data relates to, and enters data at a location corresponding to the identified unit (part of step 523).

The data received by the visualising program 215 essentially identifies a number of emails sent from an email account. The conversion of data mentioned above involves converting the number such that it can be represented graphically. Accordingly, at step 523, the visualising program 215 normalises numbers by the largest number received hitherto (or by a predetermined maximum), selects a colour depending on the normalised value (e.g. 0.8-1.0 could be red while 0.0-0.2 could be green), and paints the rectangle corresponding to the identified organisational unit the selected colour.

At the same time, and independent of visualising the email behaviour as described above, the virus detector 200 can control the spread of suspect emails. Referring to FIG. 4, the recalling program 217 receives alert data (step 525), which is indicative of email sender identifiers from which an uncharacteristically large number of emails have been sent, from the processing program 213.

Subsequently, the recalling program 217 retrieves 527 at least one of the messages sent from these identified email senders. A copy, or a “sample” of messages sent by the email senders is stored locally, on the client servers associated with the email sender identifiers, and is thus accessible by the retrieving means 217. (e.g. referring to FIG. 1a, if an email were sent from host H1 a copy of the email would be retrieved from server S1). A sample is sent 529 to a dedicated analysis centre such as the Symantec™ AntiVirus Research Center (SARC) (at July 2002, suspect viruses could be submitted to SARC for analysis thereof via a form posted at the following webpage:

\\service2.symantec.com/SUPPORT/nav.nsf/docid/2000031615501306.Usually

such a request takes the form of a first part indicating the network delivery mechanism (e.g. http:// or file:// for the hypertext transfer protocol or file transfer protocol respectively) followed by the network address of the server (e.g. www.server 1.com) suffixed with the name of the file that is being requested. Note that, in this example, such names are, for typographical reasons, shown with the “If” replaced by “\\”)).

At, or around, the same time, at step 531, the recalling program 217 recalls all of the emails sent from email accounts corresponding to the email sender identifiers for which data was received at step 525. The important point to note is that suspect emails are recalled as soon as possible; if it turns out later, in light of the results from the email analyser, that some of the recalled emails were not virus related, then those emails can be re-sent.

It could therefore be said that the disadvantage of the recall feature is late delivery of those emails that have been misclassified as suspicious. However, this is a minor inconvenience compared with selective filtering based on outdated knowledge of email viruses; as experience has borne out, when hitherto unseen (and thus not suspected) emails are allowed to promulgate through a network, the network can be paralysed. Thus, a slight delay in delivery for a minority of cases is considered to be an acceptable disadvantage.

The recall process performed by the recalling program 217 is now described in more detail with reference to FIG. 6. At step 601, upon receipt of a first list L₁, the recalling program 217 selects 601 a first destination identifier EDI₁, from the list L₁ and looks up 603 an email server corresponding to that destination identifier EDI₁ (i.e. the email server that has mailboxes corresponding to destination identifier EDI₁). When the embodiment is run in association with Microsoft™ Outlook™, this lookup typically involves accessing a so-called “Global address book”, where each user is listed, together with an email server corresponding thereto.

The recalling program 217 then sends 605 a recall message to the identified server, whereupon the server checks 607 whether the email being recalled is still stored thereon (i.e. whether it is still in the mailbox), or whether the message has already been copied to the host of its intended recipient (EDI₁).

Microsoft Outlook™ already offers a “recall” facility, which can be activated from the email client running on a host. Currently an email can be recalled only if its recipient is logged on and has neither read the message nor moved it from the email Inbox. In known systems, the software enabling the recall functionality is only implemented on a host machine, partly because recalling of emails is perceived to be a personal choice.

In comparison, the virus detector 200 can recall messages whether a user is logged on or not, by virtue of the fact that the recalling program 217 is invoked from an email server rather than from an email client. Moreover, unlike current Microsoft™ Outlook™, where each user can only control emails sent from his own email account, the recalling program 217 can send messages in respect of a plurality of email sender addresses. This is due to the fact that the recalling program 217, running on an email server, is unconstrained by individual user permissions, and can effect “mass recall” of suspicious emails. Thus, in light of current use of the recall facility, effecting recall from an email server is a surprising feature of the embodiment.

A protocol that could be used to recall and respond to receipt of recall messages is the Messaging Application Program Interface (MAPI), which is a Microsoft Windows program interface that enables e-mail to be sent from within a Windows application. MAPI can be utilised in embodiments wherein the virus detector 200 is a windows application. Alternatively, the recalling program 217 could send and receive messages using Remote Procedure calls (RPC) or TCP/IP, which is an Internet Protocol transport layer protocol. When the virus detector 200 is written to run on the Unix™ operating system, Simple Mail Transfer Protocol (SMTP) could be used to exchange messages between email servers and clients and to send messages to servers, and Post-Office Protocol v3 (POP3) could be used to retrieve messages from an email server. Other, bespoke protocols, which provide the same functionality, could also be used.

In the event that the suspect email has not yet been copied to the email client running on the host machine, the identified server sends 609 the said email back to the recalling program 217 (using MAPI); however, if the suspect email has already been copied to the email client, the server sends 611 a failure message to the recalling program 217. This process (steps 601-611) is repeated for all destination identifiers EDIⱼ in the first list L₁; and then the whole process is repeated for any other lists identified at step 525.

The recalling program 217 maintains a record of the success or otherwise of recalling the emails (step 533, FIG. 4). Once the results of the email virus analysis have been received, at step 534, the recalling program 217 proceeds to review the results. For those emails that are apparently not linked to a virus, the recalling program 217 identifies the recall status thereof (step 535), and, if the emails have been successfully recalled, the recalling program 217 causes the emails to be re-sent 537. Clearly, if the recall was unsuccessful there is no need to recall them and no further action is taken.

For those emails that are apparently linked to a virus, the recalling program 217 identifies the recall status thereof (step 535), and, if the emails have been successfully recalled, deletes 539 them. For those emails for which the recall was unsuccessful, an alert is sent (e.g. in the form of an email alert, at step 541) to the email administrator, including details of the infected emails and their destination identifiers.

In the event that each email server in the network N1 has a virus detector 200 operating thereon, the recalling program 217 could send a notification to each server from which a failure message was identified at step 535. When received at a respective server, such a notification could trigger operation of the virus detector, as described above with reference to FIGS. 2-6, on that server.

Turning now to FIGS. 7 and 8, examples of the output generated by the visualising program 215 will be discussed. In FIG. 7, four organisational units AE, BF, CH, DE are shown in grey, indicating that one or more email senders within each of these groups are sending large numbers of suspected email viruses. The numbers of emails emanating from senders within all groups for which data was received at step 521 have been normalised, as described above in relation to step 523, and classified according to their normalised values; accordingly, those organisational units from which the highest number of suspicious emails have been sent are shown in grey, whilst those from which the next highest number of suspicious emails have been sent are shown hatched. Those organisational units for which no suspicious emails have been recorded are omitted from the figure. The classifications could alternatively be shown using colours, as described a few paragraphs above.

FIG. 8 combines output from the visualising program 215 with details of the path that emails emanating from the senders were identified to have taken through the network (the path is identified using the WINS resolution of email server, described above. Email servers S1 . . . S4 are shown separately from the window 501 so as to avoid confusion between the information about email emanation, in terms of units within a company, and information about routes taken by those emails.

From the figure it can be seen that, in the case of emails sent from organisational units AE and BF, the emails only reached as far as the email servers corresponding to the destination of emails sent therefrom (S4 and S3 respectively). This is due to the fact that the recalling program 217 successfully recalled them before they were copied to the email client of the recipient. However, in the case of organisational unit GH, emails emanating therefrom were not successfully recalled, and they were copied, by email server S3, to the email clients of their intended recipients (who are in the organisational units GZ, HW, RE, VI shown in FIG. 8; paths shown as dotted lines).

Turning now to FIG. 9, the visualising program 215 can also be adapted to display details of the email sender identifiers (email account) from which the suspect emails have originated. The foregoing description has described identifying the organisational unit with which these email senders are associated; the window created by the visualising program 215 can include menu options, and/or link certain functionality with mouse clicks. When the visualising program 215 is a windows application, such functionality is provided by Java Foundation Classes (for information on writing windows applications in Java, the reader is referred to “The Java™ Virtual machine specification”, Sun Microsystems Chapter 1.2, Lindholm, T., Yellin, F. 1999). Accordingly, each rectangle 503 on the window 501 can be associated with display objects (e.g. a dialogue box), so that when the user clicks with the right button on the mouse over a rectangle 901, certain information is displayed. In one arrangement, the visualising program 215 can be arranged to display details from each of the lists Lᵢ that were received at step 521 in a dialogue box, as shown in FIG. 9.

### Second Embodiment

A second embodiment will now be described with reference to FIGS. 10, 11 and 12. The second embodiment is generally similar to that of FIGS. 2 to 9 such that like parts have been given like reference numerals and will not be described further in detail.

In the second embodiment, instead of recalling suspect emails, the recalling program 217 sends a message to the email servers to which such suspect emails have been sent, triggering a quarantine process to be run on the said email servers. The quarantine process involves preventing the means S01 from distributing incoming emails to a respective mailbox until the results of email virus analysis have been received.

Thus in the second embodiment the virus detector 200 includes a restraining program 219. As shown in FIG. 12, although a virus detector 200 includes the gathering, processing, visualising, recalling and restraining programs 211, 213, 215, 217, 219, a recalling program 215 of one virus detector 200, running on a first server S1, co-operates with a restraining program 219 of another virus detector, running on a second server S2—i.e. the email server to which emails have been sent. In fact, when emails have been sent to a plurality of email servers, the recalling program 215 running on the first server S1 will co-operate with a plurality of restraining programs 219, each running on a respective email server.

The quarantine process is now described with reference to FIG. 10. Steps 601 and 603 progress as described for the first embodiment—i.e. at step 601, upon receipt of a first list L₁, the recalling program 217 selects 601 a first destination identifier EDI₁ from the list L₁ and identifies 603 an email server corresponding to that destination identifier EDI₁ (i.e. the email server that has mailboxes corresponding to destination identifier EDI₁).

The recalling program 217 then sends 1001 a restraining message, which contains data identifying the suspect emails, to the identified server. The restraining program 219 running on the identified server checks whether emails emanating from the sending server are stored thereon, or whether the emails have already been copied to the host of its intended recipient (EDI₁).

In the event that one or more of these messages has not been copied to the recipient, the restraining program 219 removes the or each message from the mailbox, and stores it elsewhere on the server. In the event that any message has been copied to the recipient, the restraining program 219 sends a failure message to the recalling program 217 running on the sending email server. Alternatively, the restraining program 219 could send a single response to the said recalling program 217, listing all of the emails that have been copied to their recipients, when it has processed all of the restraining messages.

This process (steps 601-1005) is repeated for each destination identifier EDIⱼ in each list Lᵢ.

Once the recalling program 217 has received details of those emails that have been copied to their recipients, and has received the results of the email analysis, the recalling program 217 progresses as shown in FIG. 11. For those emails that are not viruses and have been stored by the restraining program(s) 219, the recalling program 217 sends 1103 a message to the or each restraining program 219, instructing delivery of the said emails.

For those emails that have been identified as viruses and have been stored by the restraining program(s) 219, the recalling program 217 sends 1105 a message to the or each restraining program 219, instructing deletion of the said emails.

For those emails that have been identified as viruses, and which have been copied to their recipients, the recalling program 217 sends 1107 a message to the or each email server, triggering operation of its virus detector 200 (i.e. triggering the gathering program 211 running on the server identified at step 603 to perform step 501).

It may be expected that once a virus has been identified, and indeed that the recipients of the virus have been identified, the steps 513, 515 etc.—of analysing the types of emails sent from the recipients are redundant, since the “carrier” of a virus is already known. Thus when the virus detector 200 is run on the server identified at step 603, the processing program 215 merely identifies those destination email identifiers EDIⱼ to which the virus has been sent. Furthermore the analysis steps (steps 527, 529, 534) are redundant, since it has already been established that those emails are viruses. As a result, the only steps that have to be carried out by the server identified at step 603, once the destination identifiers EDIⱼ have been identified, is recall or quarantining of the virus forwarded by hosts connected thereto. This also applies to the first embodiment.

This therefore provides automated tracking of email viruses that have been copied to a recipient.

In an alternative arrangement, the viruses could be analysed (step 534) on the email server to which the suspect emails have been sent, and the restraining program 219 could carry out the steps shown in FIG. 11 without recourse to the recalling program 217 running on the sending email server. In such an arrangement, step 1005 is redundant, while steps 1103, 1105, 1107 are run by the restraining program 219.

The second embodiment has an advantage of generating less traffic (because emails are not actually being recalled) than is generated with the first embodiment.

### Other Details and Embodiments

In the foregoing description, it is assumed that a record of email traffic is stored in a log file LF associated with an email server, so that there are as many log files as email servers, and each log file stores data relating to the email or other data traffic that has passed through its associated server.

In other arrangements, records of email traffic, connections or other data traffic could be stored in a file. That file may be monitored to detect when a criterion relating to the data traffic is met, for example, when data is sent to a threshold number of destinations.

A central log file that is associated with a firewall may be provided. In such an arrangement, there may be a single virus detector 200, which collects data from the central log file, and visualises email transmissions throughout the whole network.

As a further alternative to the arrangement shown in FIG. 2, the virus detector 200 could be distributed over a plurality of devices, such that the visualising program 215 is located separate from the other programs making up the virus detector 200. Preferably, and in the event that all email servers have a virus detector 200 running thereon, a single visualisation program 215 could be located at a central server, and each virus detector 200 could be arranged to output data to the central server. In this situation all of the email activity within a network N1 could be visualised at a central location, which facilitates easier email administration.

In one embodiment, shown in FIG. 13, a user terminal H1 has a user interface 131, here a graphical user interface, configured to request the user to input a confirmation instruction when one or more predetermined criteria are met relating to the emails the user wishes to send, which confirmation instruction causes the terminal H1 to send authentication data 138 towards a sever S1. The server S1 connected to terminal H1 directly or through a network can then use the authentication data 138 to check whether unusual email behaviour is genuine, thereby reducing the likelihood that unusual but valid email behaviour will be mistaken for a virus. Furtermore, the server S1, in particular the processing program 213 can be configured to infer, for emails meeting the predetermined criteria requiring confirmation instructions by the user, that those emails are virus emails unless authentication data is received for those emails.

To reduce the risk of a user forgetting to input confirmation instructions, the user interface 131 will preferably be configured to only permit emails meeting the predetermined criterion or criteria to be sent if the user has input the requested confirmation instruction. The user will preferably not be required to input a confirmation instruction unless the predetermined criteria are met, so that the user is not inconvenienced when only sending a few emails or emails which would not normally cause the processing program 213 to infer that the emails are caused by a virus.

The predetermined criteria may be met for example when the user sends more than a threshold number of emails. The threshold number may relate to the number of emails having the same text sent to different recipients as a batch, or the threshold number may relate to the number of emails sent from the user terminal, in particular the user, over a period of time. In this way, the predetermined criteria can invoke the confirmation requirement when suspiciously large emails or numbers of emails are sent.

A processor 132 running an email or messaging program such as Outlook™ will normally be provided on the terminal H1, the processor being additionally configured to calculate the threshold number. The user interface 131 is arranged such that the confirmation instruction from the user is mapped to data indicative of one or more characteristics or other attributes of the emails to be sent, such that the terminal H1 is able to output or otherwise produce authentication data indicative of user-confirmed attributes relating to the emails to be sent. For example, the authentication data may simply confirm that the user has sent a number of emails as a batch. Alternatively, if a predetermined criteria relates to the volume of data contained in one or more emails, the authentication data will confirm the size of the email (more or less) sent by the user.

The server S1 connected to the user terminal H1 receives the authentication data, which is stored in a user database 135 located on the server S1. When the processing program 213 running on the server S1 detects unusual email behaviour originating from the terminal H1, or in particular from a user operating from that terminal, the processing program 213 including a comparison stage 139 compares the attributes of the email behaviour with corresponding attributes entered in the user database 135 relating to that email behaviour. The processing program 213 thereby determines if the sent emails are genuinely sent by the user. In this example, the attributes to be compared are simply the number of emails sent as a batch email. If the authentication data in the user database 135 matches the number of emails sent (within a predetermined tolerance), the processing program 213 infers that the emails are genuine and does not generate alert data. Otherwise, alert data is generated and passed to the recalling program 217, which identifies the address or addresses to which the emails have been sent, and attempts to recall or suspend delivery of these emails.

The authentication data is preferably stored in the user database 135 in an encrypted form, the processor program 213 being configured to decrypt the authentication data. Although a virus email may be configured to appear as if it has been sent by a user, it will be more difficult for a virus to include the authentication data, since this data is encrypted. Furthermore, because physical user action is required for the authentication data to be generated, it will be more difficult for an email virus to trigger the generation of this data.

To make it yet more difficult for a virus to propagate, a user may be required to enter a password with the confirmation instructions. For example, the e-mail program may be configured to display a dialogue box for the user to type in the password. Thus, although a virus may be able to trigger existing messaging software into sending virus e-mails on behalf of a user, such a virus will not have reference to the password data, since the password data is not stored on the terminal, nor is it accessible to the terminal. This makes it yet less likely that a virus will be able to trigger the authentication data to be sent, and will yet further reduce the risk that a virus will propagate from the terminal.

Conveniently, the password data need only be kept secret from the authors of a virus, and hence may be more widely disseminated and/or simpler than personal passwords. For example, the password may consist of three characters or less, or possibly one or two characters, depending on the complexity of the virus the e-mail program is to be protected against.

A user terminal having an existing email or messaging program may conveniently be adapted by improvement software or other plug-in, the plug-in having improvement software which causes the email program to display a dialogue box with a confirmation button for a user to click and/or a password to enter in order to permit the emails of the user to be sent. Normally, with existing messaging software, a user is simply invited by the presence of a dialog box or window on a display to send specified emails, the dialog box or window having a button therein for the user to click. With the plug-in, the behaviour of the existing messaging program is altered, such that when a user wishes to send emails over a predetermined size or to a large number of recipients, the user is obliged perform the additional action of registering these emails as bulk mailings through the confirmation button and/or password. Each time a suspect number of emails are detected at a server from any one user or client, the user database 135 can then be checked for legality.

The authentication data may include the password data input by the user, in which case the password may but need not be encrypted before it is sent by the terminal to a server. In one embodiment, the password is simply included in an email or the header of an email intended for more than a threshold number of recipients, the server being configured to read the password and treat the password as authentication data if the password matches password data stored in the server. Thus if the correct password is received by the sever from the terminal, the email is treated as valid. This simpler embodiment allows existing messaging software to be used without modification, allowing the invention to be more easily implemented. However, since in this embodiment the user is neither invited nor obliged to confirm that the email is valid, it will be more likely that valid bulk emails will be erroneously treated as virus emails by the server. Furthermore, this embodiment requires the password data to be stored on the server. This requirement is not necessary where the aforementioned plug-in used, since the authentication data can be made independent of the password data, with the result that the password data can be updated without updating the server software responsible for reading and/or decrypting the authentication data.

As will be understood by those skilled in the art, the invention described above may be embodied in one or more computer programs. These programmes can be contained on various transmission and/or storage mediums such as a floppy disc, CD-ROM, or magnetic tape so that the programmes can be loaded onto one or more general purpose computers or could be downloaded over a computer network using a suitable transmission medium.

Unless the context clearly requires otherwise, throughout the description and the claims, the words “comprise”, “comprising” and the like are to be construed in an inclusive as opposed to an exclusive or exhaustive sense; that is to say, in the sense of “including, but not limited to”.

1. A server configured to send outgoing electronic messages on behalf of terminals connected thereto and to deliver incoming electronic messages to the terminals, each terminal being accessed by one or more users, the server comprising: receiving means arranged to generate or receive log data relating to one or more traffic characteristics associated with electronic messages; analysing means arranged to analyse the log data in accordance with a criterion, so as to identify those electronic messages that satisfy the criterion; identifying means arranged to identify the destination of the identified electronic messages; processing means arranged to send a message to each of the identified destinations, requesting suspension of delivery of the identified electronic messages.

2. A server according to claim 1, including first means arranged to receive a signal identifying whether or not an identified electronic message is related to an electronic message virus, second means arranged to receive data indicative of the success or otherwise of the request, and, in the event that the received signal identifies an electronic message to be a virus and the request is successful, to trigger deletion of the said electronic message.

3. A server according to claim 2, wherein, in the event that a received signal identifies an electronic message to be a virus and the request is unsuccessful, the second means is arranged to trigger operation of identifying means and processing means running on a server corresponding to the destination of the identified electronic message.

4. A server according to claim 2, wherein, in the event that a received signal identifies an electronic message not to be a virus and the request is successful, the second means is arranged to permit delivery of the identified electronic message.

5. A server according to claim 1, including first storage for storing details relating to such electronic messages; further storage for storing a mapping between users and the organisational units to which the users belong, display means for displaying a plurality of images, each representative of an organisational unit; wherein the server is arranged, in use, such that in response to a request for data relating to a user, the first storage is arranged to output data identifying electronic messages emanating from that user; the further storage is arranged to output data identifying which of the organisational units that user belongs to; and, for those electronic messages that are identified to satisfy the criterion, the display means is arranged to insert, on the image corresponding to the identified organisational unit, a visual identifier representative of the volume or type of identified electronic messages.

6. A server according to claim 5, wherein, for those electronic messages that are identified to satisfy the criterion, the display means is arranged to display a list of users on an associated image, and for each user on the list, to display details of the volume and/or type of identified electronic messages emanating therefrom.

7. A server according to claim 6, wherein the display means is arranged to insert a link between the identified organisational unit and the organisational unit corresponding to the identified destination.

8. Apparatus for delivering electronic messages, comprising a plurality of servers according to claim 1; wherein at least one of the servers comprises: receiving means arranged to receive a request to suspend delivery of an identified electronic message; polling means arranged to check whether or not the identified electronic message has been delivered, and if it has not, to block retrieval thereof by a respective terminal connected thereo; wherein, in response to receipt of a said request, the polling means is arranged to check delivery of the identified electronic message, and in the event that it has not been delivered, to block retrieval thereof.

9. Apparatus according to claim 8, wherein the at least one server includes deleting means for deleting an electronic message, and, in response to receipt of a signal identifying that an identified electronic message is related to an electronic message virus, the deleting means is arranged to check whether retrieval of the identified electronic message has been blocked, and if it has, to delete it.

10. Apparatus according to claim 8, wherein, in the event that the identified electronic message is related to an electronic message virus, and the identified electronic message has not been blocked, the server is arranged to invoke its identifying means and processing means in respect of electronic messages sent by the identified destinations.

11. Apparatus according to claim 1, wherein the criterion includes any one, or some, of type of electronic message, size of electronic message and number of electronic messages emanating from a user.

12. A method of controlling propagation of electronic messages through a network, the network comprising a plurality of servers configured to send outgoing electronic messages on behalf of terminals connected thereto and to deliver incoming electronic messages to the terminals, each terminal being accessed by one or more users, the method comprising receiving or generating data relating to one or more traffic characteristics associated with electronic messages sent from, or received at, a said server; analysing the received data in accordance with a specified criterion, so as to identify those electronic messages that satisfy the criterion; identifying the destination of the identified electronic messages; and sending a message to each of the identified destinations, requesting suspension of delivery of the identified electronic messages.

13. A method according to claim 12, including receiving a signal identifying whether or not an identified electronic message is related to an electronic message virus, receiving data indicative of the success or otherwise of the request, and, in the event that the received signal identifies an electronic message to be a virus and the request is successful, triggering deletion of the said electronic message.

14. A method according to claim 13, wherein, in the event that a received signal identifies an electronic message to be a virus and the request is unsuccessful, the method includes triggering the identifying and sending steps to be carried out in respect of a server corresponding to the destination of the identified electronic message.

15. A method according to claim 13, wherein, in the event that a received signal identifies an electronic message not to be a virus and the request is successful, the method includes triggering delivery of the identified electronic message.

16. A method according to claim 12, including receiving data identifying a mapping between users and the organisational units to which the users belong, displaying a plurality of images, each representative of an organisational unit; outputting data identifying the users who originated the electronic messages that are identified to satisfy the criterion; identifying, from the mapping, which of the organisational units those users belong to; and, inserting, on an image corresponding to the identified organisational units, visual identifiers representative of the volume or type of identified electronic messages.

17. A method according to claim 16, wherein, for those electronic messages that are identified to satisfy the criterion, the method includes displaying a list of users on an associated image, and for each user on the list, displaying details of the volume and/or type of identified electronic messages emanating therefrom.

18. A method according to claim 17, including inserting a link between the identified organisational unit and the organisational unit corresponding to the identified destination.

19. A method according to claim 1, wherein the criterion includes any one, or some, of type of electronic message, size of electronic message and number of electronic messages emanating from a user.

20. A method of identifying electronic message activity within an organisation, the organisation having a plurality of users associated therewith, each of which is connected with an organisational unit, the method comprising: receiving data relating to electronic messages sent by a user; analysing the received data in accordance with a specified criterion, so as to identify those electronic messages that satisfy the criterion; receiving data identifying a mapping between users and the organisational units to which the users belong, displaying a plurality of images, each representative of an organisational unit; outputting data identifying the users who originated the electronic messages that are identified to satisfy the criterion; identifying, from the mapping, which of the organisational units the users belong to; and inserting, on an image corresponding to the identified organisational units, visual identifiers representative of the volume or type of identified electronic messages.

21. A method according to claim 20, wherein the criterion includes any one, or some, of type of electronic message, size of electronic message and number of electronic messages emanating from a user.

22. A computer program, or a suite of computer programs, comprising a set of instructions to cause a computer, or a suite of computers, to perform the method according to claim 12.

23. A server configured to send outgoing electronic messages on behalf of terminals connected thereto and to deliver incoming electronic messages to the terminals, each terminal being accessed by one or more users, the server comprising: logging means arranged to generate log data relating to one or more traffic characteristics associated with electronic messages; and, analysing means to analyse the received data in accordance with a specified criterion, so as to identity those electronic messages that satisfy the criterion.

24. A server according to claim 23, the server comprising identifying means arranged to identify the destination of the identified electronic messages; and, processing means arranged to send a message to each of the identified destinations, requesting suspension of delivery of the identified electronic messages.

25. A server according to claim 1, the server being arranged to receive authentication data from a terminal connected thereto, the authentication data being associated with one or more electronic messages, the server having a comparison stage configured to make a comparison between the log data relating to an identified message and the authentication data associated with that message, the processing means being arranged to execute a decision to send a suspension request to the identified destination of that message in dependence on the comparison made by the comparison stage.

26. A server according to claim 25, wherein the authentication data is received in encrypted form, the comparison stage being configured to decrypt the encrypted authentication data and to compare the decrypted data with the log data.

27. A terminal for sending and receiving electronic messages to and from a server according to claim 25, wherein the terminal has an interface, the interface having a user input for receiving send instructions to send one or more specified electronic messages to a server, the user input being configured to receive a confirmation input from the user to confirm the send instructions and wherein in response to the confirmation input, the terminal is configured to send the specified electronic messages towards the server and to send authentication data associable with the specified electronic messages.

28. A terminal according to claim 27 wherein the terminal is configured to detect whether a criterion relating to the specified electronic message is met, and to request a confirmation input from a user at the user interface in response to the criterion being met.

29. A terminal according to claim 27, wherein the terminal is configured to transmit the authenticating data in encrypted form.

30. A carrier having a computer program stored thereon, the computer program being executable on a terminal so as to cause the terminal to operate according to the terminal specified in claim 27.

31. A carrier having a computer program thereon for sending and receiving electronic messages, the program being executable on a terminal having a user interface, the computer program being configured to perform the following steps when executed: (a) invite a user to input at the user interface send instructions for sending one or more electronic messages; (b) determine if a criterion relating to the electronic messages is met; (c) if the criterion is met, invite the user to input at the user interface a confirmation input to confirm the send instructions; (d) upon receipt of the confirmation input, transmit the electronic messages from the terminal; and (e) transmit authentication data associable with the transmitted electronic message (s).

32. A carrier having an improvement computer program, the improvement computer program being executable on a terminal having electronic messaging software running thereon, so as to reduce the likelihood of a computer virus using the messaging software to propagate from the terminal, the messaging software being configured to invite the user to input at the user interface send instructions for sending one or more specified electronic messages, and in response to the send instructions, to transmit the messages from the terminal, the improvement computer program being configured when executed to; (a) invite a user to input confirmation instructions at the user interface to confirm the send instructions; (b) only permit the user to send electronic messages once the user has input the confirmation instructions; and, (c) upon receipt of the confirmation instructions, cause the terminal to transmit therefrom authentication data associable with the specified messages.

33. A carrier according to claim 31, wherein the authentication data is transmitted encrypted form.

34. A carrier according to claim 31, wherein the computer program thereon is configured, when executed, to request a user to input password data as part of the confirmation instructions, and to only permit the terminal to send authentication data once the password data has been input by the user.

35. A server according to claim 1, wherein the criterion is met if the log data relating to a target electronic message indicates that a threshold number of electronic messages and/or a threshold data volume originates from a common terminal or user, in a time interval during which the target electronic message was sent.

36. A server configured to send outgoing electronic messages on behalf of terminals connected thereto and to deliver incoming electronic messages to the terminals, each terminal being accessed by one or more users, the server comprising: receiving means arranged to generate or receive log data relating to such electronic messages; analysing means arranged to analyse the log data in accordance with a specified criterion, so as to identify those electronic messages that satisfy the criterion; identifying means arranged to identify the destination of the identified electronic messages; processing means arranged to send a message to each of the identified destinations, requesting suspension of delivery of the identified electronic messages.
